(19) United States
(12) Patent Application Publication
(10) Pub. No.: US 2026/0045870 A1
(43) Pub. Date: Feb. 12, 2026

(54) BUCK CIRCUIT, AND DEVICE AND CONTROL METHOD THEREFOR

(71) Applicant: Zhuhai Nanxin Semiconductor Technology Co., Ltd., Zhuhai City, Guangdong Province (CN)

(72) Inventor: Xuan Luo, Zhuhai City (CN)

(21) Appl. No.: 19/295,472

(22) Filed: Aug. 8, 2025

(30) Foreign Application Priority Data
Aug. 8, 2024 (CN) 202411091566.X

(51) Int. Cl. H02M 3/07; H02M 1/32

(52) U.S. Cl. CPC H02M 3/072; H02M 1/32

(57) ABSTRACT

Embodiments of the present disclosure provide a buck circuit, and a device and a control method therefor. The buck circuit includes four power transistors, a flying capacitor, an inductor, a first capacitor, a first switching module, and a switching control module. The switching control module is configured to control the first switching module to turn on when controlling the first power transistor and the third power transistor to turn on such that the first capacitor and the flying capacitor are connected in series, and further configured to control the first switching module to turn on when controlling the second power transistor and the fourth power transistor to turn on such that the first capacitor and the flying capacitor are connected in parallel. The buck circuit according to the embodiments of the present disclosure improves efficiency and prevent over-voltage damage.

### CROSS-REFERENCE TO RELATED APPLICATION

This application is based upon and claims the priority of Chinese Patent Application No. 202411091566.X, filed on Aug. 8, 2024, the entire content of which is hereby incorporated by reference herein and made a part of this specification.

### TECHNICAL FIELD

The present disclosure relates to the technical field of switched-mode power supplies, and in particular, relates to a buck circuit, and a device and a control method therefore.

### BACKGROUND

A three-level buck circuit is a high-efficiency buck (step-down) circuit widely applied in electronic devices, which is configured to reduce to step down a high supply voltage from a power supply terminal of the electronic device to a required system supply voltage or battery voltage.

In the related art, the three-level Buck circuit typically includes four power transistors, an inductor, and a flying capacitor.

However, the conventional three-level Buck circuit suffers from a problem where the flying capacitor is prone to voltage imbalance, which results in reduced efficiency or over-voltage damage.

### SUMMARY

Embodiments of the present disclosure provide a buck circuit, and a device and a control method therefor, to improve efficiency and prevent over-voltage damage.

In a first aspect, the embodiments of the present disclosure provide a buck circuit. The buck circuit includes:
a first power transistor, a second power transistor, a third power transistor, a fourth power transistor, a flying capacitor, an inductor, a first capacitor, a first switching module, and a switching control module; wherein
a first terminal of the first power transistor is electrically connected to a voltage input terminal, a second terminal of the first power transistor and a first terminal of the second power transistor are electrically connected to a first connection point, a second terminal of the second power transistor and a first terminal of the third power transistor are electrically connected to a second connection point, a second terminal of the third power transistor and a first terminal of the fourth power transistor are electrically connected to a third connection point, and a second terminal of the fourth power transistor is grounded; one terminal of the flying capacitor is electrically connected to the first connection point, and another terminal of the flying capacitor is electrically connected to the third connection point; and one terminal of the inductor is electrically connected to the second connection point, and another terminal of the inductor is electrically connected to a voltage output terminal;
a first terminal of the first capacitor is electrically connected to the second connection point via the first switching module, and a second terminal of the first capacitor is grounded; and
the switching control module is electrically connected to control terminals of the first power transistor, the second power transistor, the third power transistor, the fourth power transistor, and the first switching module, and is configured to control the first switching module to turn on when controlling the first power transistor and the third power transistor to turn on such that the first capacitor and the flying capacitor are connected in series, and further configured to control the first switching module to turn on when controlling the second power transistor and the fourth power transistor to turn on such that the first capacitor and the flying capacitor are connected in parallel.

In some embodiments, the buck circuit further includes: a second switching module, wherein one terminal of the second switching module is electrically connected to the second connection point, and another terminal of the second switching module is electrically connected to the voltage output terminal; and
the switching control module is electrically connected to the second switching module, and is further configured to generate a switching drive signal with a duty cycle of 50% and control on or off of the first power transistor, the second power transistor, the third power transistor, and the fourth power transistor, and meanwhile control the first switching module and the second switching module to turn on so that the buck circuit implements functionality of a charge pump.

In some embodiments, the first switching module includes a first switching transistor and a second switching transistor;
wherein a first terminal of the first switching transistor is electrically connected to a first terminal of the second switching transistor, a second terminal of the first switching transistor is electrically connected to the first terminal of the first capacitor, and a second terminal of the second switching transistor is electrically connected to the second connection point.

In some embodiments, the buck circuit further includes: a second switching module, wherein one terminal of the second switching module is electrically connected to the first terminal of the first switching transistor, and another terminal of the second switching module is electrically connected to the voltage output terminal; and
the switching control module is electrically connected to the second switching module, and is further configured to generate a switching drive signal with a duty cycle of 50% and control on or off of the first power transistor, the second power transistor, the third power transistor, and the fourth power transistor, and meanwhile control the first switching module and the second switching module to turn on so that the buck circuit implements functionality of a charge pump.

In some embodiments, the second switching module includes a third switching transistor and a fourth switching transistor;
wherein a first terminal of the third switching transistor is electrically connected to a first terminal of the fourth switching transistor, a second terminal of the third switching transistor is electrically connected to the first terminal of the first switching transistor, and a second terminal of the fourth switching transistor is electrically connected to the voltage output terminal.

In some embodiments, the second switching module includes a fifth switching transistor;
wherein a first terminal of the fifth switching transistor is electrically connected to the first terminal of the first switching transistor, and a second terminal of the fifth switching transistor is electrically connected to the voltage output terminal.

In some embodiments, the switching control module is further configured to control the first power transistor and the second power transistor to remain on, and control the third power transistor and the fourth power transistor to remain off, and control the first switching module and the second switching module to remain on to implement a pass-through mode.

In some embodiments, the buck circuit further includes a third switching module; wherein
the second switching module is electrically connected to the voltage output terminal via the third switching module; and a common connection point between the third switching module and the second switching module is electrically connected to one terminal of a battery, and another terminal of the battery is grounded; and
the switching control module is electrically connected to the third switching module, and is configured to control the third switching module to turn on to charge the battery when a voltage of the battery is less than a first predetermined value or supply a voltage to the voltage output terminal via a battery when a voltage input at the voltage input terminal is less than a second predetermined value.

In some embodiments, the third switching module includes a sixth switching transistor; wherein a first terminal of the sixth switching transistor is electrically connected to the second switching module, and a second terminal of the sixth switching transistor is electrically connected to the voltage output terminal.

In some embodiments, the second switching module includes a seventh switching transistor; wherein a first terminal of the seventh switching transistor is electrically connected to the first terminal of the first switching transistor, and a second terminal of the seventh switching transistor is electrically connected to a common connection point between the third switching module and the second switching module.

In a second aspect, the embodiments of the present disclosure provides a control method for a buck circuit, applicable to a buck circuit, wherein the buck circuit includes: a first power transistor, a second power transistor, a third power transistor, a fourth power transistor, a flying capacitor, an inductor, a first capacitor, a first switching module, and a switching control module; wherein a first terminal of the first power transistor is electrically connected to a voltage input terminal, a second terminal of the first power transistor and a first terminal of the second power transistor are electrically connected to a first connection point, a second terminal of the second power transistor and a first terminal of the third power transistor are electrically connected to a second connection point, a second terminal of the third power transistor and a first terminal of the fourth power transistor are electrically connected to a third connection point, and a second terminal of the fourth power transistor is grounded; one terminal of the flying capacitor is electrically connected to the first connection point, and another terminal of the flying capacitor is electrically connected to the third connection point; and one terminal of the inductor is electrically connected to the second connection point, and another terminal of the inductor is electrically connected to a voltage output terminal; a first terminal of the first capacitor is electrically connected to the second connection point via the first switching module, and a second terminal of the first capacitor is grounded; the switching control module is electrically connected to control terminals of the first power transistor, the second power transistor, the third power transistor, the fourth power transistor, and the first switching module; and the method includes:
controlling, via the switching control module, the first switching module to turn on when controlling the first power transistor and the third power transistor to turn on such that the first capacitor and the flying capacitor are connected in series, and further configured to control the first switching module to turn on when controlling the second power transistor and the fourth power transistor to turn on such that the first capacitor and the flying capacitor are connected in parallel.

In a third aspect, the embodiments of the present disclosure further provide an electronic device. The electronic device includes: an adapter and a buck circuit as described above; wherein
the adapter is electrically connected to the buck circuit, and is configured to convert an input alternating current voltage to a direct current voltage, and output the direct current voltage to the buck circuit; and
the buck circuit is configured to perform a buck conversion for the direct current voltage to generate a direct current output voltage, wherein the direct current output voltage is less than or equal to the direct current voltage.

The buck circuit according to the embodiments of the present disclosure includes: a first power transistor, a second power transistor, a third power transistor, a fourth power transistor, a flying capacitor, an inductor, a first capacitor, a first switching module, and a switching control module; wherein a first terminal of the first power transistor is electrically connected to a voltage input terminal, a second terminal of the first power transistor and a first terminal of the second power transistor are electrically connected to a first connection point, a second terminal of the second power transistor and a first terminal of the third power transistor are electrically connected to a second connection point, a second terminal of the third power transistor and a first terminal of the fourth power transistor are electrically connected to a third connection point, and a second terminal of the fourth power transistor is grounded; one terminal of the flying capacitor is electrically connected to the first connection point, and another terminal of the flying capacitor is electrically connected to the third connection point; and one terminal of the inductor is electrically connected to the second connection point, and another terminal of the inductor is electrically connected to a voltage output terminal; a first terminal of the first capacitor is electrically connected to the second connection point via the first switching module, and a second terminal of the first capacitor is grounded; the switching control module is electrically connected to control terminals of the first power transistor, the second power transistor, the third power transistor, the fourth power transistor, and the first switching module, and is configured to control the first switching module to turn on when controlling the first power transistor and the third power transistor to turn on and controlling the second power transistor and the fourth power transistor to turn on. In the buck circuit according to the embodiments of the present disclosure, a voltage balancer circuit is defined for the flying capacitor by additionally providing a capacitor (i.e., the first capacitor) and a switching transistor (i.e., the first switching module). By pre-charging the capacitor in the voltage balancer circuit to 0.5*Vin, where Vin is the input voltage, and connecting the capacitor in series and parallel to the flying capacitor at an appropriate timing during operation of the buck circuit, a voltage of the flying capacitor is stabilized at 0.5*Vin in each cycle, such that efficiency is improved and over-voltage damage is prevented.

### BRIEF DESCRIPTION OF THE DRAWINGS

For clearer descriptions of the technical solutions according to the embodiments of the present disclosure or in the related art, the following briefly introduces the accompanying drawings required for describing the embodiments or the related art. Apparently, the accompanying drawings in the following description show some embodiments of the present disclosure, and a person of ordinary skill in the art may still derive other drawings from these accompanying drawings without creative efforts.

FIG. 1a is a schematic structural diagram of a three-level buck circuit in the related art.

FIG. 1b is a schematic structural diagram of operating waveforms of the three-level buck circuit in the related art.

FIG. 2 is a first schematic structural diagram of a buck circuit according to some embodiments of the present disclosure.

FIG. 3 is a second schematic structural diagram of the buck circuit according to some embodiments of the present disclosure.

FIG. 4 is a first schematic structural diagram of operating waveforms of the buck circuit according to some embodiments of the present disclosure.

FIGS. 5(a) to 5(d) are first schematic structural diagrams of a switching mode of the buck circuit according to some embodiments of the present disclosure.

FIG. 6 is a third schematic structural diagram of the buck circuit according to some embodiments of the present disclosure.

FIG. 7 is a fourth schematic structural diagram of the buck circuit according to some embodiments of the present disclosure.

FIG. 8 is a fifth schematic structural diagram of the buck circuit according to some embodiments of the present disclosure.

FIG. 9 is a second schematic structural diagram of the operating waveforms of the buck circuit according to some embodiments of the present disclosure.

FIG. 10 (a) and FIG. 10 (b) are second schematic structural diagrams of the switching mode of the buck circuit according to some embodiments of the present disclosure.

FIG. 11 is a third schematic structural diagram of the operating waveforms of the buck circuit according to some embodiments of the present disclosure.

FIG. 12 is a third schematic structural diagram of the switching mode of the buck circuit according to some embodiments of the present disclosure.

FIG. 13 is a sixth schematic structural diagram of the buck circuit according to some embodiments of the present disclosure.

FIG. 14 is a seventh schematic structural diagram of the buck circuit according to some embodiments of the present disclosure.

Reference numerals and denotations thereof:
Q1: first power transistor;
Q2: second power transistor;
Q3: third power transistor;
Q4: fourth power transistor;
CFLY: flying capacitor;
L: inductor;
Caux: first capacitor;
N1: first connection point;
VSW: second connection point;
N2: third connection point;
201: switching control module;
202: first switching module;
203: second switching module; and
204: third switching module.

### DETAILED DESCRIPTION

For clearer descriptions of the objectives, technical solutions, and advantages of the embodiments of the present disclosure, the following clearly and completely describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

It should be noted that a buck circuit, and a device and a control method therefor according to the embodiments of the present disclosure may be applied in the field of switching power supplies, and may also be applicable to any field other than the field of switching power supplies. The application fields of the buck circuit, and the device and the control method therefor according to the embodiments of the present disclosure are not limited.

A three-level buck circuit is a high-efficiency buck (step-down) circuit widely applied in electronic devices, which is configured to reduce to step down a high supply voltage from a power supply terminal of an electronic device to a required system supply voltage or battery voltage.

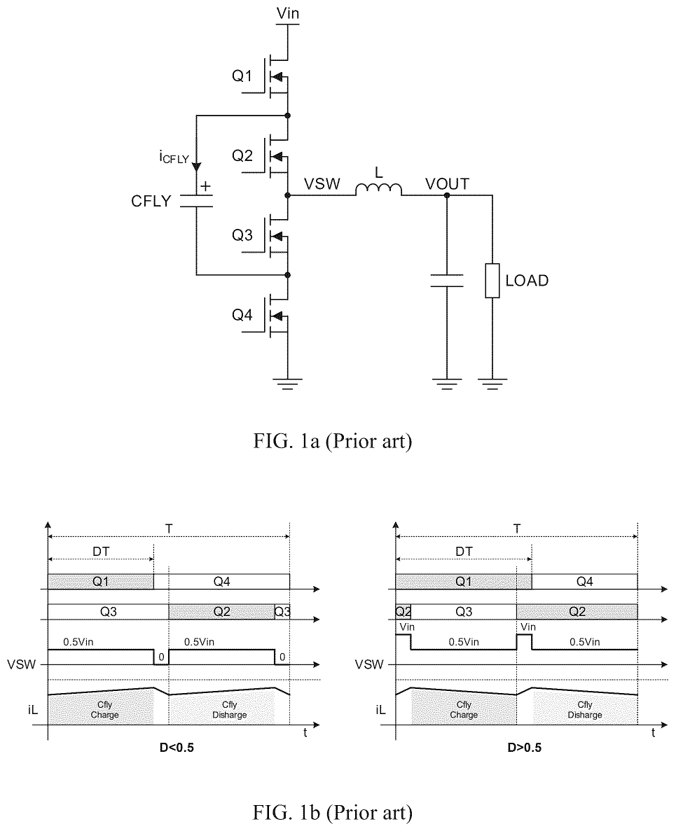

For a typical structure of the three-level buck circuit, reference may be made to FIG. 1a. As illustrated in FIG. 1a, the three-level buck circuit mainly includes a first power transistor Q1, a second power transistor Q2, a third power transistor Q3, a fourth power transistor Q4, an inductor L, and a flying capacitor CFLY. A drive signal for the first power transistor Q1 has a duty cycle defined as D. A drive signal for the fourth power transistor Q4 is complementary to the drive signal for the first power transistor Q1. A drive signal for the second power transistor Q2 also has a duty cycle of D but is 180 degrees out of phase with the drive signal for the first power transistor Q1. A drive signal for the third power transistor Q3 is complementary to the drive signal for the second power transistor Q2.

Assuming that, before the three-level buck circuit operates, a voltage of the flying capacitor CFLY, VCF, is pre-charged to 0.5*Vin, wherein Vin is an input voltage of the three-level buck circuit. FIG. 1b is a schematic diagram of an operating waveform of the three-level buck circuit, wherein, iL represents a current of the inductor L, “Cfly Charge” represents charging of the flying capacitor CFLY, and “Cfly Discharge” represents discharging of the flying capacitor CFLY.

As illustrated in a left part of FIG. 1b, in a case where D<0.5:

When the first power transistor Q1 and the third power transistor Q3 are turned on simultaneously, a voltage at the second connection point VSW is Vin−VCF=0.5*Vin; and voltages withstood by the second power transistor Q2 and the fourth power transistor Q4 are VCF and Vin-VCF respectively, wherein VCF is the voltage of the flying capacitor CFLY.

When the fourth power transistor Q4 and the third power transistor Q3 are turned on simultaneously, the voltage at the second connection point VSW is 0; and voltages withstood by the first power transistor Q1 and the second power transistor Q2 are Vin-VCF and VCF respectively.

When the fourth power transistor Q4 and the second power transistor Q2 are turned on simultaneously, the voltage at the second connection point VSW is VCF=0.5*Vin; and voltages withstood by the first power transistor Q1 and the third power transistor Q3 are Vin-VCF and VCF respectively.

When the fourth power transistor Q4 and the third power transistor Q3 are turned on simultaneously, the voltage at the second connection point VSW is 0; and voltages withstood by the first power transistor Q1 and the second power transistor Q2 are Vin-VCF and VCF respectively.

As illustrated in a right part of FIG. 1b, in a case where D>0.5:

When the first power transistor Q1 and the second power transistor Q2 are turned on simultaneously, a voltage at the second connection point VSW is Vin; and voltages withstood by the third power transistor Q3 and the fourth power transistor Q4 are VCF and Vin−VCF respectively.

When the first power transistor Q1 and the third power transistor Q3 are turned on simultaneously, the voltage at the second connection point VSW is Vin−VCF−0.5*Vin; and voltages withstood by the second power transistor Q2 and the fourth power transistor Q4 are VCF and Vin−VCF, respectively.

When the first power transistor Q1 and the second power transistor Q2 are turned on simultaneously, the voltage at the second connection point VSW is Vin; and voltages withstood by the third power transistor Q3 and the fourth power transistor Q4 are VCF and Vin-VCF respectively.

When the fourth power transistor Q4 and the second power transistor Q2 are turned on simultaneously, the voltage at the second connection point VSW is VCF=0.5*Vin; and voltages withstood by the first power transistor Q1 and the third power transistor Q3 are Vin-VCF and VCF respectively.

In a case where D=0.5, the operation is equivalent to retaining only two modes: the first power transistor Q1 and the third power transistor Q3 are turned on simultaneously, and the fourth power transistor Q4 and the second power transistor Q2 are turned on simultaneously, which are not described herein any further.

As obtained from the above analysis, the voltage at the second connection point VSW may switch among three levels (Vin, 0.5*Vin, and 0). Compared to a conventional two-level buck circuit (which switches between Vin and 0), this reduces a volt-second product of the inductor, such that inductor current ripples and circuit losses are reduced. The voltage withstood by each of the first power transistor Q1, the second power transistor Q2, the third power transistor Q3, and the fourth power transistor Q4 during an off-state is 0.5*Vin. Compared to a conventional two-level buck circuit (Vin), this allows for the selection of switching transistors with a lower withstand voltage to reduce losses or lower costs. Therefore, ensuring that VCF−0.5*Vin is of paramount importance for the operation of the three-level buck circuit.

However, the three-level buck circuit as illustrated in FIG. 1a suffers from the following technical problems:

Problem 1: The flying capacitor CFLY is prone to voltage imbalance (i.e., when VCF≠0.5*Vin), which results in reduced efficiency or over-voltage damage. Under ideal conditions, the amount of charge supplied to and drawn from the flying capacitor CFLY within one cycle remains equal, and thus the voltage of the flying capacitor CFLY may always be maintained at 0.5*Vin. In practice, however, due to inconsistencies or mismatches in control and drive circuits, a discrepancy may be present between the duty cycles of the first power transistor Q1 and the second power transistor Q2. This discrepancy may lead to a difference between charging and discharging durations for the flying capacitor CFLY, which in turn causes VCF to deviate from 0.5*Vin. Consequently, the voltage at the second connection point VSW deviates from 0.5*Vin when it is supposed to be Vin-VCF or VCF, leading to increased output ripples. Alternatively, the voltage withstood, which equals to Vin-VCF or VCF, by the power transistors (i.e., the first power transistor Q1, the second power transistor Q2, the third power transistor Q3, and the fourth power transistor Q4) may exceed 0.5*Vin, causing over-voltage damage to the switching transistors.

Problem 2: The output needs to pass through an inductor, resulting in a significantly lower efficiency compared to a charge pump circuit. As a closed-loop circuit, the three-level buck circuit requires an inductor to achieve a voltage regulation capability. An inductor, which requires a conductor to be wound into coils to acquire inductance, inherently has a significant direct current resistance (DCR), causing substantial power losses. However, to reduce their own temperature rise, mobile devices such as smart phones and smart watches are increasingly adopting inductorless, high-efficiency, open-loop charge pump buck circuits, which rely on an external smart power adapter for voltage regulation. The structure of a charge pump buck circuit with a 2:1 input-to-output conversion ratio is equivalent to that of a three-level buck circuit with the inductor removed from its output and the duty cycle D fixed at 0.5.

With respect to Problem 1, in the technical solution according to the embodiments of the the present disclosure, a first capacitor Caux may be additionally pre-charged to 0.5*Vin, and the first capacitor Caux may be connected in series or parallel to the flying capacitor CFLY at an appropriate timing during operation of the buck circuit. This establishes an equality relationship that ensures that the voltage of the flying capacitor CFLY is maintained at 0.5*Vin.

With respect to Problem 2, in the technical solution according to the embodiments of the the present disclosure, a switch may be arranged short-circuit the inductor, thereby enabling a charge pump mode of operation.

The technical solutions according to the present disclosure are described in detail with reference to some specific embodiments. It should be noted that the specific embodiments described hereinafter may be combined with one another, and for identical or similar concepts or processes, description thereof may not be repeated in some embodiments.

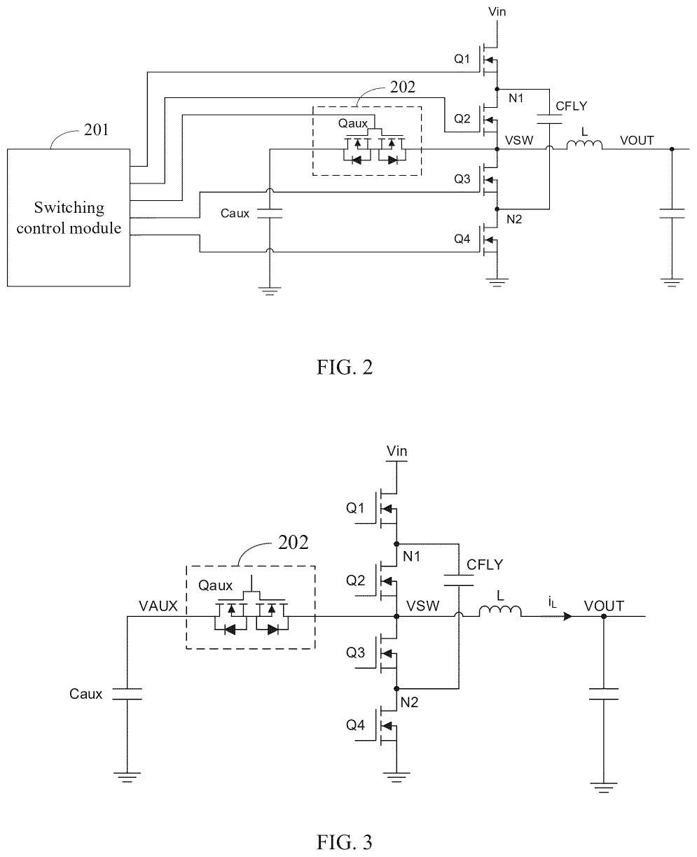

FIG. 2 is a first schematic structural diagram of a buck circuit according to some embodiments of the present disclosure. As illustrated in FIG. 2, the buck circuit includes a first power transistor Q1, a second power transistor Q2, a third power transistor Q3, a fourth power transistor Q4, a flying capacitor CFLY, an inductor L, a first capacitor Caux, a first switching module 202, and a switching control module 201.

A first terminal of the first power transistor Q1 is electrically connected to a voltage input terminal Vin, a second terminal of the first power transistor Q1 and a first terminal of the second power transistor Q2 are electrically connected to a first connection point N1, a second terminal of the second power transistor Q2 and a first terminal of the third power transistor Q3 are electrically connected to a second connection point VSN, a second terminal of the third power transistor Q3 and a first terminal of the fourth power transistor Q4 are electrically connected to a third connection point N2, and a second terminal of the fourth power transistor Q4 is grounded; one terminal of the flying capacitor CFLY is electrically connected to the first connection point N1, and another terminal of the flying capacitor CFLY is electrically connected to the third connection point N2; and one terminal of the inductor L is electrically connected to the second connection point VSW, and another terminal of the inductor L is electrically connected to a voltage output terminal VOUT.

A first terminal of the first capacitor Caux is electrically connected to the second connection point VSW via the first switching module 202, and a second terminal of the first capacitor Caux is grounded.

The switching control module 201 is electrically connected to control terminals of the first power transistor Q1, the second power transistor Q2, the third power transistor Q3, the fourth power transistor Q4, and the first switching module 202, and is configured to control the first switching module 202 to turn on when controlling the first power transistor Q1 and the third power transistor Q3 to turn on such that the first capacitor Caux and the flying capacitor CFLY are connected in series, and further configured to control the first switching module 202 to turn on when controlling the second power transistor Q2 and the fourth power transistor Q4 to turn on such that the first capacitor Caux and the flying capacitor CFLY are connected in parallel.

In the buck circuit according to the embodiments, by adding the first switching module 202 and the first capacitor Caux, where the first switching module 202 may be a switching transistor Qaux, the following is achieved within one switching cycle: By turning on the switching transistor Qaux during on-time of the first power transistor Q1 and the third power transistor Q3, the first capacitor Caux and the flying capacitor CFLY may be connected in series for being charged; by turning on the switching transistor Qaux during on-time of the second power transistor Q2 and the fourth power transistor Q4, the first capacitor Caux and the flying capacitor CFLY may be connected in parallel for voltage balancing and discharging. This method ensures that voltages of the first capacitor Caux and the flying capacitor CFLY are equal to each other and equal to 0.5*Vin. Therefore, this helps to improve the buck circuit efficiency and reduce the risk of device over-voltage.

In the embodiments, the switching control module 201 may be electrically connected to a microcontroller unit (MCU), the voltage input terminal VIN, the voltage output terminal VOUT, and the second connection point VSW, and is configured to generate a switching drive signal based on a control signal from the MCU, an output voltage Vout at the voltage output terminal VOUT, and a current IL of the inductor L acquired from the second connection point VSW, to control on or off of the first power transistor Q1, the second power transistor Q2, the third power transistor Q3, the fourth power transistor Q4, and the first switching module 202.

In the embodiments, power transistors such as the first power transistor Q1, the second power transistor Q2, the third power transistor Q3, and the fourth power transistor Q4 may be metal-oxide-semiconductor field-effect transistors (MOSFETs). The first terminal may be a drain, the second terminal may be a source, and the control terminal may be a gate.

In some embodiments, an input voltage Vin may be a direct current voltage acquired from an adapter that converts a high alternating current voltage (e.g., 220 V).

As illustrated in FIG. 3, compared to conventional three-level buck circuits, this buck circuit adds a first switching module 202 (which may also be referred to as an auxiliary switching transistor Qaux) and a first capacitor Caux (which may also be referred to as an auxiliary capacitor Caux) to achieve voltage balancing for the flying capacitor CFLY:

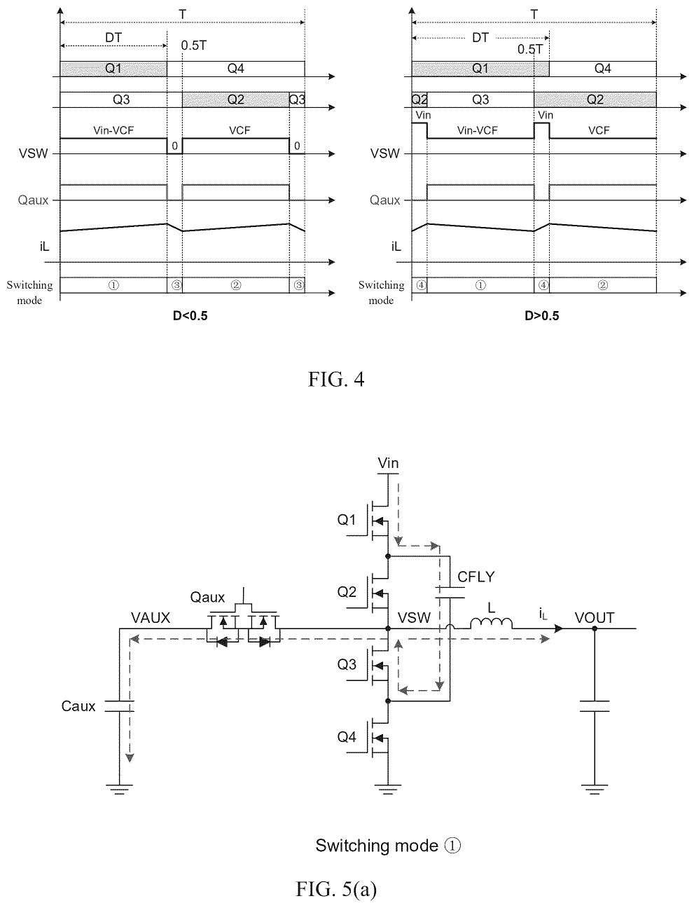

Prior to operation of the buck circuit, the first capacitor Caux and the flying capacitor CFLY are pre-charged to 0.5*Vin. During operation of the buck circuit, voltage balancing for the flying capacitor CFLY is achieved by controlling the auxiliary switching transistor Qaux to turn on at an appropriate timing. As an example, within one switching cycle T: When the first power transistor Q1 and the third power transistor Q3 are turned on simultaneously, the auxiliary switching transistor Qaux is driven to turn on, such that the flying capacitor CFLY and the auxiliary capacitor Caux are connected in series. This yields an equation Vin=VCF+VAUX, wherein VCF is the voltage of the flying capacitor CFLY and VAUX is an voltage of the auxiliary capacitor Caux. When the second power transistor Q2 and the fourth power transistor Q4 are turned on simultaneously, the flying capacitor CFLY and the auxiliary capacitor Caux are connected in parallel. This yields an equation VCF=VAUX. Solving these two equations simultaneously yields VCF=VAUX=0.5*Vin, that is, achieving voltage balancing for the flying capacitor CFLY. For waveforms of the buck circuit with the auxiliary switching transistor Qaux added, reference may be made to FIG. 4.

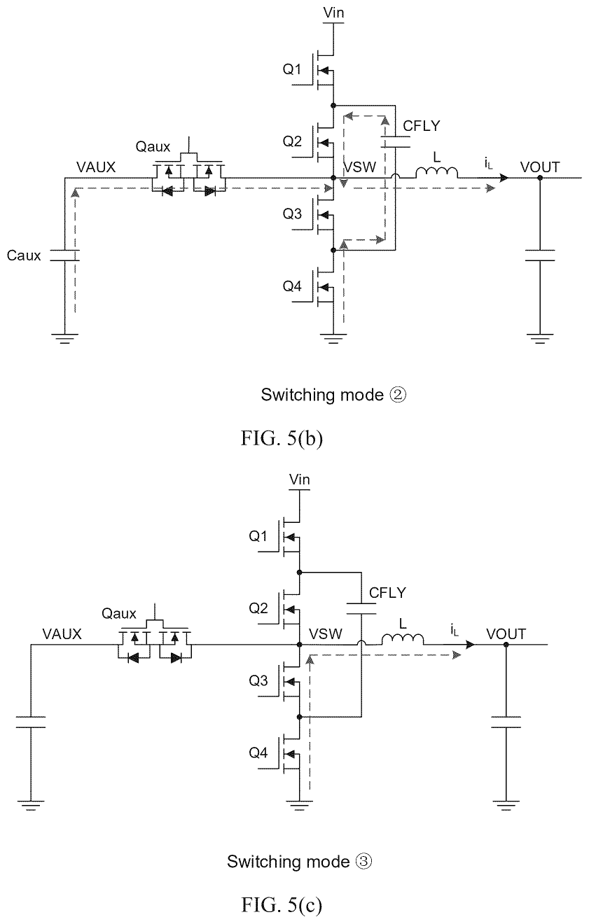

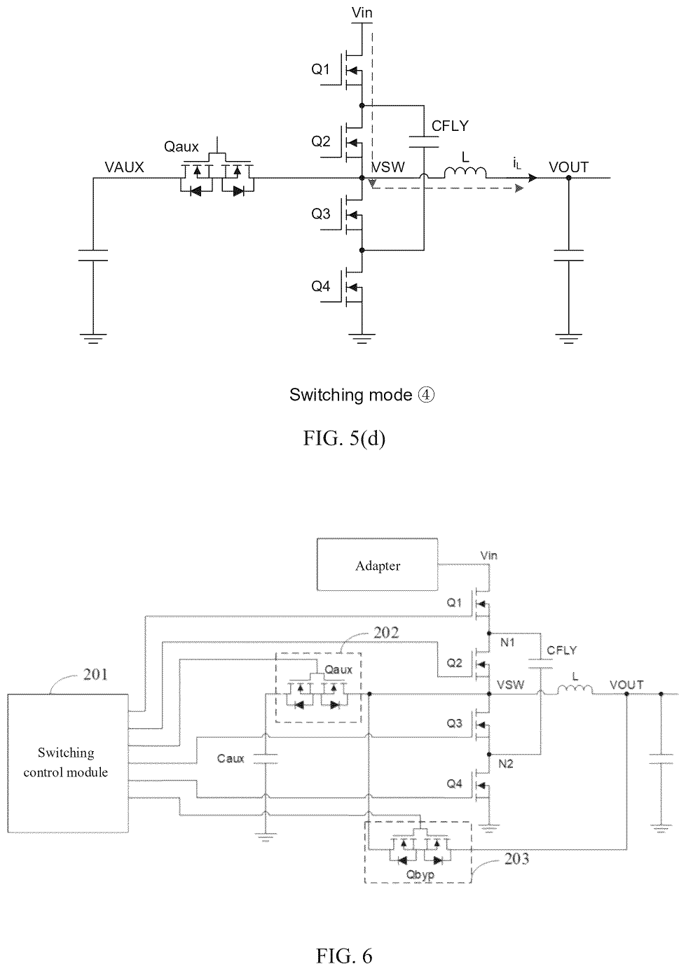

For details about a current path for each switching mode, reference may be made to FIGS. 5(a) to 5(d). The current may flow in a positive direction indicated by arrows in FIGS. 5(a) to 5(d), or may flow in a reverse direction. In a case where D<0.5 and D>0.5, the waveforms of the buck circuit in FIG. 4 may be described as follows respectively.

For a switching mode 1: The first power transistor Q1 and the third power transistor Q3 are turned on, and the auxiliary switching transistor Qaux is turned on. The auxiliary capacitor Caux and the flying capacitor CFLY are connected in series between the voltage input terminal VIN and the ground, such that Vin=VCF+VAUX. The voltage at the second connection point VSW is Vin-VCF.

For a switching mode 2: The second power transistor Q2 and the fourth power transistor Q4 are turned on, and the auxiliary switching transistor Qaux is turned on. The auxiliary capacitor Caux and the flying capacitor CFLY are connected in parallel, such that VCF=VAUX. The voltage at the second connection point VSW is VCF.

For a switching mode 3: The third power transistor Q3 and the fourth power transistor Q4 are turned on, and the auxiliary switching transistor Qaux is turned off. The voltage at the second connection point VSW is 0.

For a switching mode 4: The first power transistor Q1 and the second power transistor Q2 are turned on, and the auxiliary switching transistor Qaux is turned off. The voltage at the second connection point VSW is Vin.

In the buck circuit according to the embodiments of the present disclosure, a voltage balancer circuit is defined for the flying capacitor by additionally arranging an auxiliary capacitor and an auxiliary switching transistor. By pre-charging the auxiliary capacitor in the voltage balancer circuit to 0.5*Vin, and connecting the auxiliary capacitor in series and parallel to the flying capacitor at an appropriate timing during operation of the buck circuit, a voltage of the flying capacitor is stabilized at 0.5*Vin in each cycle, such that efficiency is improved and over-voltage damage is prevented.

In some embodiments, to improve voltage withstanding capabilities and avoid short circuits, back-to-back transistors may be used as the auxiliary switching transistor in the embodiments. Specifically, the first switching module 202 may include a first switching transistor and a second switching transistor. A first terminal of the first switching transistor is electrically connected to a first terminal of the second switching transistor, a second terminal of the first switching transistor is electrically connected to a first terminal of the first capacitor Caux, and a second terminal of the second switching transistor is electrically connected to the second connection point VSW.

In a case where the first terminal of the first switching transistor and the first terminal of the second switching transistor are both sources(S), the second terminal of the first switching transistor and the second terminal of the second switching transistor are both drains (D). Alternatively, in a case where the first terminal of the first switching transistor and the first terminal of the second switching transistor are both drains (D), the second terminal of the first switching transistor and the second terminal of the second switching transistor are both sources(S).

FIG. 6 is a fourth schematic structural diagram of the buck circuit according to some embodiments of the present disclosure. On the basis of the above embodiments, for example, the embodiment illustrated in FIG. 2, a new switching module is added to solve Problem 2 by short-circuiting the inductor L, and a voltage withstanding requirement for the new switching module is low. Specifically, the buck circuit includes a first power transistor Q1, a second power transistor Q2, a third power transistor Q3, a fourth power transistor Q4, a flying capacitor CFLY, an inductor L, a first capacitor Caux, a first switching module 202, and a switching control module 201.

A first terminal of the first power transistor Q1 is electrically connected to a voltage input terminal Vin, a second terminal of the first power transistor Q1 and a first terminal of the second power transistor Q2 are electrically connected to a first connection point N1, a second terminal of the second power transistor Q2 and a first terminal of the third power transistor Q3 are electrically connected to a second connection point VSN, a second terminal of the third power transistor Q3 and a first terminal of the fourth power transistor Q4 are electrically connected to a third connection point N2, and a second terminal of the fourth power transistor Q4 is grounded; one terminal of the flying capacitor CFLY is electrically connected to the first connection point N1, and another terminal of the flying capacitor CFLY is electrically connected to the third connection point N2; and one terminal of the inductor L is electrically connected to the second connection point VSW, and another terminal of the inductor L is electrically connected to a voltage output terminal VOUT.

A first terminal of the first capacitor Caux is electrically connected to the second connection point VSW via the first switching module 202, and a second terminal of the first capacitor Caux is grounded.

The switching control module 201 is electrically connected to control terminals of the first power transistor Q1, the second power transistor Q2, the third power transistor Q3, the fourth power transistor Q4, and the first switching module 202, and is configured to control the first switching module 202 to turn on when controlling the first power transistor Q1 and the third power transistor Q3 to turn on such that the first capacitor Caux and the flying capacitor CFLY are connected in series, and further configured to control the first switching module 202 to turn on when controlling the second power transistor Q2 and the fourth power transistor Q4 to turn on such that the first capacitor Caux and the flying capacitor CFLY are connected in parallel.

The buck circuit further includes a second switching module 203. One terminal of the second switching module 203 is electrically connected to the second connection point, and another terminal of the second switching module 203 is electrically connected to the voltage output terminal VOUT.

The switching control module 201 is electrically connected to the second switching module 203, and is further configured to generate a switching drive signal with a duty cycle of 50%, and based on the switching drive signal, control on or off of the first power transistor Q1, the second power transistor Q2, the third power transistor Q3, and the fourth power transistor Q4, and meanwhile control the first switching module 202 and the second switching module 203 to turn on so that the buck circuit implements functionality of a charge pump.

In the embodiments, the structure of the second switching module 203 may take various forms. In one possible implementation, to improve voltage withstanding capabilities and avoid short circuits, the second switching module 203 may be composed of two back-to-back transistors. Specifically, the second switching module 203 may include a third switching transistor and a fourth switching transistor. A first terminal of the third switching transistor is electrically connected to a first terminal of the fourth switching transistor, a second terminal of the third switching transistor is electrically connected to the second connection point, and a second terminal of the fourth switching transistor is electrically connected to the voltage output terminal VOUT.

In a case where the first terminal of the third switching transistor and the first terminal of the fourth switching transistor are both sources(S), the second terminal of the third switching transistor and the second terminal of the fourth switching transistor are both drains (D). Alternatively, in a case where the first terminal of the third switching transistor and the first terminal of the fourth switching transistor are both drains (D), the second terminal of the third switching transistor and the second terminal of the fourth switching transistor are both sources(S).

In some embodiments, based on the second switching module 203 (i.e., switching transistor Qbyp) is electrically connected to an end of the first switching module 202 (i.e., switching transistor Qaux) that is electrically connected to the second connection point VSW, the second switching transistor of the first switching module 202 does not need to suffer from large currents, a smaller-sized switching transistor may be used. Specifically, the second switching module 203 may include a fifth switching transistor. A first terminal of the fifth switching transistor is electrically connected to the second connection point VSW, and a second terminal of the fifth switching transistor is electrically connected to the voltage output terminal VOUT.

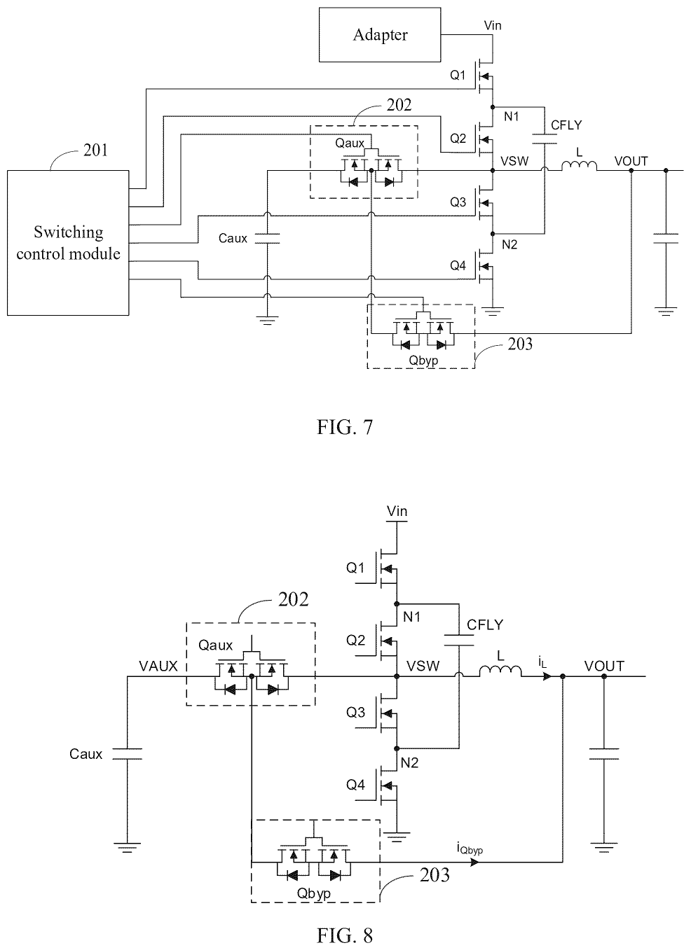

FIG. 7 is a fourth schematic structural diagram of the buck circuit according to some embodiments of the present disclosure. On the basis of the above embodiments, for example, the embodiment illustrated in FIG. 2, a new switching module is added to solve problem 2 by short-circuiting the inductor L, and a voltage withstanding requirement for the new switching module is low. Specifically, the buck circuit includes a first power transistor Q1, a second power transistor Q2, a third power transistor Q3, a fourth power transistor Q4, a flying capacitor CFLY, an inductor L, a first capacitor Caux, a first switching module 202, and a switching control module 201.

A first terminal of the first power transistor Q1 is electrically connected to a voltage input terminal Vin, a second terminal of the first power transistor Q1 and a first terminal of the second power transistor Q2 are electrically connected to a first connection point N1, a second terminal of the second power transistor Q2 and a first terminal of the third power transistor Q3 are electrically connected to a second connection point VSN, a second terminal of the third power transistor Q3 and a first terminal of the fourth power transistor Q4 are electrically connected to a third connection point N2, and a second terminal of the fourth power transistor Q4 is grounded; one terminal of the flying capacitor CFLY is electrically connected to the first connection point N1, and another terminal of the flying capacitor CFLY is electrically connected to the third connection point N2; and one terminal of the inductor L is electrically connected to the second connection point VSW, and another terminal of the inductor L is electrically connected to a voltage output terminal VOUT.

A first terminal of the first capacitor Caux is electrically connected to the second connection point VSW via the first switching module 202, and a second terminal of the first capacitor Caux is grounded.

The switching control module 201 is electrically connected to control terminals of the first power transistor Q1, the second power transistor Q2, the third power transistor Q3, the fourth power transistor Q4, and the first switching module 202, and is configured to control the first switching module 202 to turn on when controlling the first power transistor Q1 and the third power transistor Q3 to turn on such that the first capacitor Caux and the flying capacitor CFLY are connected in series, and further configured to control the first switching module 202 to turn on when controlling the second power transistor Q2 and the fourth power transistor Q4 to turn on such that the first capacitor Caux and the flying capacitor CFLY are connected in parallel.

The buck circuit further includes a second switching module 203. One terminal of the second switching module 203 is electrically connected to the first terminal of the first switching transistor, and another terminal of the second switching module 203 is electrically connected to the voltage output terminal VOUT.

The switching control module 201 is electrically connected to the second switching module 203, and is further configured to generate a switching drive signal with a duty cycle of 50%, and based on the switching drive signal, control on or off of the first power transistor Q1, the second power transistor Q2, the third power transistor Q3, and the fourth power transistor Q4, and meanwhile control the first switching module 202 and the second switching module 203 to turn on so that the buck circuit implements functionality of a charge pump.

In the embodiments, the structure of the second switching module 203 may take various forms. In one possible implementation, to improve voltage withstanding capabilities and avoid short circuits, the second switching module 203 is composed of two back-to-back transistors. Specifically, the second switching module 203 may include a third switching transistor and a fourth switching transistor. A first terminal of the third switching transistor is electrically connected to a first terminal of the fourth switching transistor, a second terminal of the third switching transistor is electrically connected to the first terminal of the first switching transistor, and a second terminal of the fourth switching transistor is electrically connected to the voltage output terminal VOUT.

In some embodiments, based on the withstand voltage requirement is lower when the second switching module 203 (i.e., switching transistor Qbyp) is electrically connected to the first switching module 202 (i.e., switching transistor Qaux), a bidirectional switching transistor composed of a special structure transistor with a grounded substrate may be used to reduce on-resistance. Specifically, the second switching module 203 may include a fifth switching transistor. A first terminal of the fifth switching transistor is electrically connected to a first terminal of the first switching transistor, and a second terminal of the first switching transistor is electrically connected to the voltage output terminal VOUT. The first terminal of the fifth switching transistor may be either a source(S) or a drain (D), and correspondingly, the second terminal of the fifth switching transistor is a drain (D) or a source(S).

The operating principles of the buck circuit illustrated in FIG. 6 and the buck circuit illustrated in FIG. 7 are similar. Herein, the operating process is described using the buck circuit illustrated in FIG. 7 as an example.

As an example, the buck circuit illustrated in FIG. 7 is simplified to yield the buck circuit illustrated in FIG. 8. As illustrated in FIG. 8, by connecting a second switching module 203 (Qbyp) connected to a midpoint of the first switching module 202 (Qaux) to the output terminal, the function of bypassing the inductor L may be implemented. Since a maximum voltage at the midpoint of the first switching module 202 (Qaux) is only VAUX+VD, wherein VD is a forward voltage drop of a body diode of the first switching transistor of the first switching module 202 (Qaux), a switching transistor with a lower withstand voltage may be used as the second switching module 203 (Qbyp).

In the specific operating process, the buck circuit illustrated in FIG. 8 has three operating modes.

In a first operating mode: In a case where the buck circuit operates in a three-level buck mode, the second switching module 203 (Qbyp) remains off. The first switching module 202 (Qaux) and the first power transistor Q1, the second power transistor Q2, the third power transistor Q3, and the fourth power transistor Q4 operate in the manner according to the previously described embodiments, which is not described herein any further.

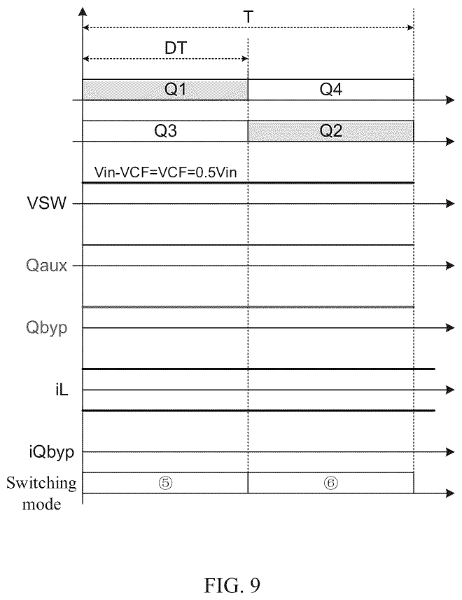

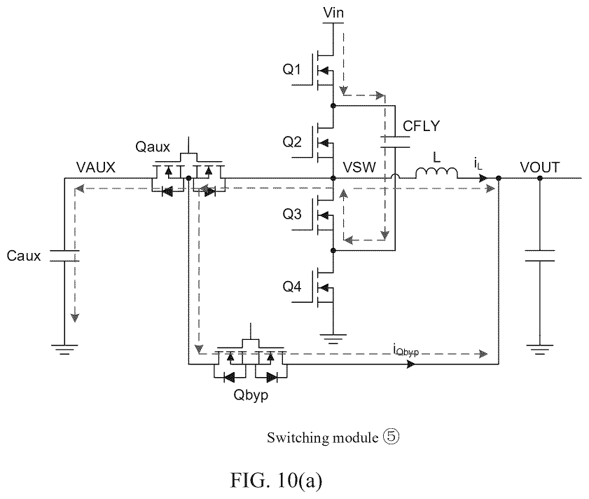

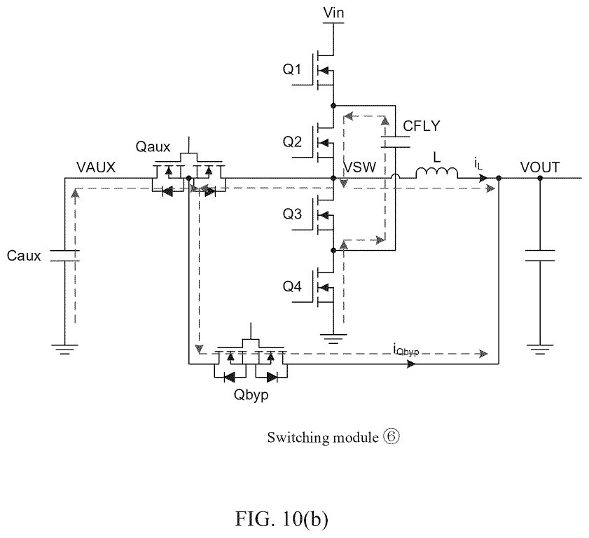

In a second operating mode: In a case where the buck circuit operates operating in a 2:1 charge pump mode, both the first switching module 202 (Qaux) and the second switching module 203 (Qbyp) remain on. The first power transistor Q1, the second power transistor Q2, the third power transistor Q3, and the fourth power transistor Q4 operate with a duty cycle D=0.5. In this operating mode, the buck circuit is equivalent to a 2:1 charge pump circuit. For details about the waveforms of the buck circuit, reference may be made to FIG. 9. For details about a current path for each switching mode, reference may be made to FIG. 10 (a) and FIG. 10 (b). The current may flow in a positive direction indicated by arrows in FIG. 10 (a) and FIG. 10 (b), or may flow in a reverse direction indicated by arrows in FIG. 10 (a) and FIG. 10 (b).

In a case where D=0.5, the waveforms of the buck circuit illustrated in FIG. 9 may be described as follows.

For a switching mode 5: The first power transistor Q1 and the third power transistor Q3 are turned on, and the first switching module 202 (Qaux) and the second switching module 203 (Qbyp) are turned on. The first capacitor Caux and the flying capacitor CFLY are connected in series between the voltage input terminal Vin and ground, such that Vin=VCF+VAUX. The voltage at the second connection point VSW is Vin−VCF=VCF=0.5*Vin.

For a switching mode 6: The second power transistor Q2 and the fourth power transistor Q4 are turned on, and the first switching module 202 (Qaux) and the second switching module 203 (Qbyp) are turned on. The first capacitor Caux and the flying capacitor CFLY are connected in parallel, such that VCF=VAUX. The voltage at the second connection point VSW is VCF.

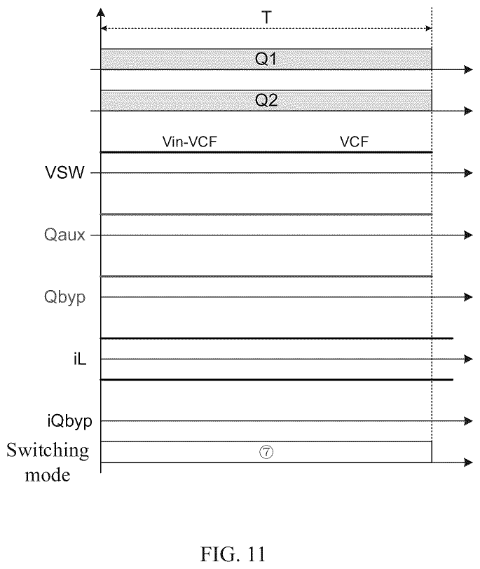

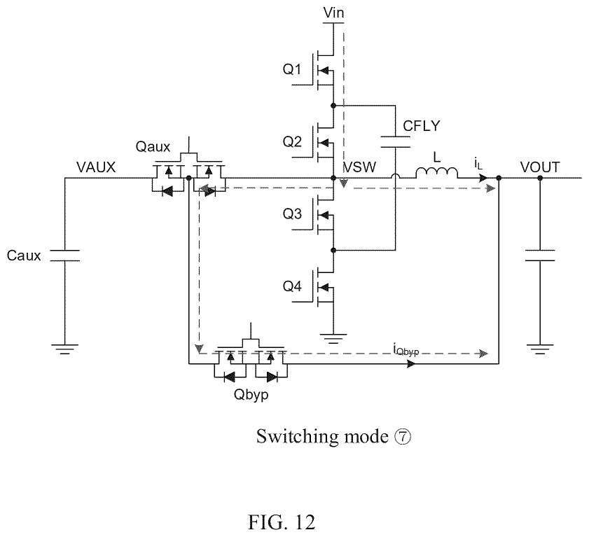

In a third operating mode: When operating in a 1:1 pass-through mode, the first switching module 202 (Qaux), the second switching module 203 (Qbyp), the first power transistor Q1, and the second power transistor Q2 all remain on. The third power transistor Q3 and the fourth power transistor Q4 remain off. For details about the buck circuit waveform, reference may be made to FIG. 11. For details about the current path for switching mode 7, reference may be made to FIG. 12. The current may flow in a positive direction indicated by arrows in FIG. 12, or may flow in a reverse direction.

For a switching mode 7: Throughout the entire switching cycle T, the first power transistor Q1 and the second power transistor Q2 are turned on, the third power transistor Q3 and the fourth power transistor Q4 are turned off, and the first switching module 202 (Qaux) and the second switching module 203 (Qbyp) are turned on. The voltage at the second connection point VSW is Vin.

In FIG. 9 and FIG. 11, iL represents a current of the inductor L, and iQbyp represents a current of the second switching module 203.

In some embodiments, the switching control module 201 is further configured to control the first power transistor Q1 and the second power transistor Q2 to remain on, and control the third power transistor Q3 and the fourth power transistor Q4 to remain off, and control the first switching module 202 and the second switching module 203 to remain on to implement a pass-through mode.

In the buck circuit according to the embodiments, by connecting the second switching module 203 (Qbyp) to the midpoint of the first switching module 202 (Qaux), a voltage that the second switching module 203 (Qbyp) transistor needs to withstand in a worst-case scenario is only 0.5*Vin+VD (wherein VD is small, generally around 0.7 V). Therefore, this helps to use devices with a lower withstand voltage, and improves circuit efficiency.

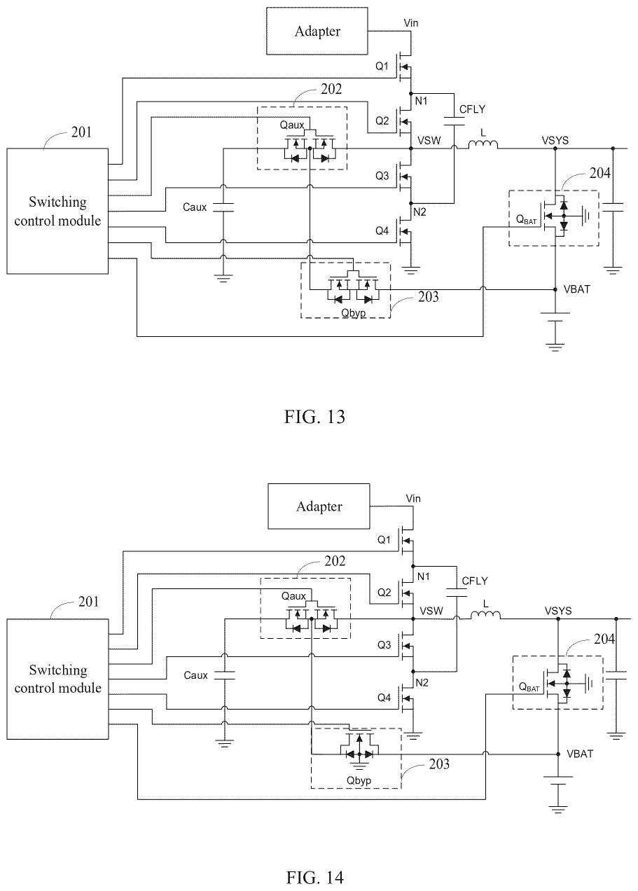

FIG. 13 is a sixth schematic structural diagram of the buck circuit according to some embodiments of the present disclosure. As illustrated in FIG. 13, on the basis of the above embodiments, for example, on the basis of the embodiment illustrated in FIG. 7, a third switching module 204 is added so that the buck circuit is applied in a narrow voltage direct current (NVDC) power architecture. Specifically, the buck circuit includes a first power transistor Q1, a second power transistor Q2, a third power transistor Q3, a fourth power transistor Q4, a flying capacitor CFLY, an inductor L, a first capacitor Caux, a first switching module 202, and a switching control module 201.

A first terminal of the first power transistor Q1 is electrically connected to a voltage input terminal Vin, a second terminal of the first power transistor Q1 and a first terminal of the second power transistor Q2 are electrically connected to a first connection point N1, a second terminal of the second power transistor Q2 and a first terminal of the third power transistor Q3 are electrically connected to a second connection point VSN, a second terminal of the third power transistor Q3 and a first terminal of the fourth power transistor Q4 are electrically connected to a third connection point N2, and a second terminal of the fourth power transistor Q4 is grounded; one terminal of the flying capacitor CFLY is electrically connected to the first connection point N1, and another terminal of the flying capacitor CFLY is electrically connected to the third connection point N2; and one terminal of the inductor L is electrically connected to the second connection point VSW, and another terminal of the inductor L is electrically connected to a voltage output terminal VOUT.

A first terminal of the first capacitor Caux is electrically connected to the second connection point VSW via the first switching module 202, and a second terminal of the first capacitor Caux is grounded.

The switching control module 201 is electrically connected to control terminals of the first power transistor Q1, the second power transistor Q2, the third power transistor Q3, the fourth power transistor Q4, and the first switching module 202, and is configured to control the first switching module 202 to turn on when controlling the first power transistor Q1 and the third power transistor Q3 to turn on such that the first capacitor Caux and the flying capacitor CFLY are connected in series, and further configured to control the first switching module 202 to turn on when controlling the second power transistor Q2 and the fourth power transistor Q4 to turn on such that the first capacitor Caux and the flying capacitor CFLY are connected in parallel.

The buck circuit further includes a second switching module 203. One terminal of the second switching module 203 is electrically connected to the first terminal of the first switching transistor, and another terminal of the second switching module 203 is electrically connected to the voltage output terminal VOUT.

The switching control module 201 is electrically connected to the second switching module 203, and is further configured to generate a switching drive signal with a duty cycle of 50%, and based on the switching drive signal, control on or off of the first power transistor Q1, the second power transistor Q2, the third power transistor Q3, and the fourth power transistor Q4, and meanwhile control the first switching module 202 and the second switching module 203 to turn on so that the buck circuit implements functionality of a 2:1 charge pump.

The buck circuit further includes a third switching module 204. The second switching module 203 is electrically connected to the voltage output terminal VOUT via the third switching module 204. A common connection point between the third switching module 204 and the second switching module 203 is electrically connected to one terminal of a battery, and another terminal of the battery is grounded. The switching control module 201 is electrically connected to the third switching module 204, and is configured to control the third switching module 204 to turn on to charge the battery when a voltage of the battery is less than a first predetermined value or control the battery to supply a voltage to the voltage output terminal VOUT when a voltage at the voltage output terminal VIN is less than a second predetermined value.

The buck circuit according to the embodiments of the present disclosure may be applied to a narrow voltage direct current (NVDC) architecture. Specifically, by adding a third switching module 204 (i.e., a bidirectional switch QBAT) at the output terminal to isolate the system supply terminal VSYS from the battery terminal VBAT, and connecting the second switching module 203 (Qbyp) to the battery terminal VBAT, the following is achieved.

In three-level buck, 2:1 charge pump, and 1:1 pass-through modes, in a case where the battery does not has sufficient charge, the bidirectional switch QBAT may operate in a forward low dropout (LDO) mode. The system power supply terminal VSYS charges the battery while simultaneously supplying a normal supply voltage to the system.

In the three-level buck, 2:1 charge pump, and 1:1 pass-through modes, in a case where the adapter power is insufficient or the adapter is not present, but the battery has sufficient charge, the bidirectional switch QBAT may be turned on in reverse, such that the battery terminal VBAT is allowed to supply power to the system supply terminal VSYS.

In the 2:1 charge pump or the 1:1 pass-through mode, the second switching module 203 (Qbyp) bypasses not only the inductor L but also the bidirectional switch QBAT. This minimizes the overall impedance and maximizes the energy conversion efficiency.

In some embodiments, the third switching module 204 includes a sixth switching transistor. A first terminal of the sixth switching transistor is electrically connected to the second switching module 203, and a second terminal of the sixth switching transistor is electrically connected to the voltage output terminal VOUT. The first terminal of the sixth switching transistor may be either a source(S) or a drain (D), and correspondingly, the second terminal of the sixth switching transistor is a drain (D) or a source(S).

In some embodiments, to further reduce on-resistance, the buck circuit is provided, as illustrated in FIG. 14, the second switching module 203 includes a seventh switching transistor. A first terminal of the seventh switching transistor is electrically connected to the first terminal of the first switching transistor, and a second terminal of the seventh switching transistor is electrically connected to a common connection point between the third switching module 204 and the second switching module 203. The first terminal of the seventh switching transistor may be either a source(S) or a drain (D), and correspondingly, the second terminal of the seventh switching transistor is a drain (D) or a source(S).

In the buck circuit according to the embodiments, by adding a switching module between the system power supply terminal and the battery terminal, an NVDC charging architecture is implemented.

It should be noted that the connection in the buck circuit illustrated in FIG. 6 may be applied between the first switching module 202 (Qaux) and the second switching module 203 (Qbyp) in the buck circuits illustrated in FIG. 13 and FIG. 14. The operating principles are similar, which are not described herein any further.

Some embodiments of the present disclosure further provide an electronic device. The electronic device includes an adapter and the buck circuit as described above. The adapter is electrically connected to the buck circuit, and is configured to convert an input alternating current voltage into a direct current voltage and output the direct current voltage to the buck circuit. The buck circuit is configured to perform a buck conversion for the direct current voltage to generate a direct current output voltage, wherein the direct current output voltage is less than or equal to the direct current voltage.

In the electronic device according to the embodiments of the present disclosure, a voltage balancer circuit is defined for the flying capacitor by additionally arranging a first capacitor Caux and a first switching module 202 (Qaux). By pre-charging the first capacitor in the voltage balancer circuit to 0.5*Vin, and connecting the first capacitor in series and parallel to the flying capacitor at an appropriate timing during operation of the buck circuit, a voltage of the flying capacitor is stabilized at 0.5*Vin in each cycle, such that efficiency is improved and over-voltage damage is prevented.

Some embodiments of the present disclosure further provide a control method for a buck circuit, which is applied to the buck circuit according to the above embodiments. The buck circuit includes: a first power transistor, a second power transistor, a third power transistor, a fourth power transistor, a flying capacitor, an inductor, a first capacitor, a first switching module, and a switching control module; wherein a first terminal of the first power transistor is electrically connected to a voltage input terminal, a second terminal of the first power transistor and a first terminal of the second power transistor are electrically connected to a first connection point, a second terminal of the second power transistor and a first terminal of the third power transistor are electrically connected to a second connection point, a second terminal of the third power transistor and a first terminal of the fourth power transistor are electrically connected to a third connection point, and a second terminal of the fourth power transistor is grounded; one terminal of the flying capacitor is electrically connected to the first connection point, and another terminal of the flying capacitor is electrically connected to the third connection point; and one terminal of the inductor is electrically connected to the second connection point, and another terminal of the inductor is electrically connected to a voltage output terminal; a first terminal of the first capacitor is electrically connected to the second connection point via the first switching module, and a second terminal of the first capacitor is grounded; the switching control module is electrically connected to control terminals of the first power transistor, the second power transistor, the third power transistor, the fourth power transistor, and the first switching module. The method includes: controlling, via the switching control module, the first switching module to turn on when controlling the first power transistor and the third power transistor to turn on such that the first capacitor and the flying capacitor are connected in series, and further configured to control the first switching module to turn on when controlling the second power transistor and the fourth power transistor to turn on such that the first capacitor and the flying capacitor are connected in parallel.

In the control method for the buck circuit according to the embodiments of the present disclosure, a voltage balancer circuit is composed by a first capacitor Caux and a first switching module 202 (Qaux), and is defined for the flying capacitor. By pre-charging the first capacitor in the voltage balancer circuit to 0.5*Vin, and connecting the first capacitor in series or parallel to the flying capacitor at an appropriate timing during operation of the buck circuit, a voltage of the flying capacitor is stabilized at 0.5*Vin in each cycle, such that efficiency is improved and over-voltage damage is prevented.

It should be finally noted that the above-described embodiments are merely for illustration of the present disclosure, but are not intended to limit the present disclosure. Although the present disclosure is described in detail with reference to these embodiments, a person skilled in the art may also make various modifications to the technical solutions disclosed in the embodiments, or make equivalent replacements to a part of or all technical features contained therein. Such modifications or replacement, made without departing from the principles of the present disclosure, shall fall within the scope of the present disclosure.

What is claimed is:

1. A buck circuit, comprising: a first power transistor, a second power transistor, a third power transistor, a fourth power transistor, a flying capacitor, an inductor, a first capacitor, a first switching module, and a switching control module; wherein
a first terminal of the first power transistor is electrically connected to a voltage input terminal, a second terminal of the first power transistor and a first terminal of the second power transistor are electrically connected to a first connection point, a second terminal of the second power transistor and a first terminal of the third power transistor are electrically connected to a second connection point, a second terminal of the third power transistor and a first terminal of the fourth power transistor are electrically connected to a third connection point, and a second terminal of the fourth power transistor is grounded; one terminal of the flying capacitor is electrically connected to the first connection point, and another terminal of the flying capacitor is electrically connected to the third connection point; and one terminal of the inductor is electrically connected to the second connection point, and another terminal of the inductor is electrically connected to a voltage output terminal;
a first terminal of the first capacitor is electrically connected to the second connection point via the first switching module, and a second terminal of the first capacitor is grounded; and
the switching control module is electrically connected to control terminals of the first power transistor, the second power transistor, the third power transistor, the fourth power transistor, and the first switching module, and is configured to control the first switching module to turn on when controlling the first power transistor and the third power transistor to turn on such that the first capacitor and the flying capacitor are connected in series, and further configured to control the first switching module to turn on when controlling the second power transistor and the fourth power transistor to turn on such that the first capacitor and the flying capacitor are connected in parallel.

2. The buck circuit according to claim 1, further comprising: a second switching module, wherein one terminal of the second switching module is electrically connected to the second connection point, and another terminal of the second switching module is electrically connected to the voltage output terminal;
the switching control module is electrically connected to the second switching module, and is further configured to generate a switching drive signal with a duty cycle of 50% and control on or off of the first power transistor, the second power transistor, the third power transistor, and the fourth power transistor, and meanwhile control the first switching module and the second switching module to turn on to implement functionality of a charge pump.

3. The buck circuit according to claim 2, wherein the second switching module comprises a third switching transistor and a fourth switching transistor;
wherein a first terminal of the third switching transistor is electrically connected to a first terminal of the fourth switching transistor, a second terminal of the third switching transistor is electrically connected to the second connection point, and a second terminal of the fourth switching transistor is electrically connected to the voltage output terminal.

4. The buck circuit according to claim 2, wherein the second switching module comprises a fifth switching transistor;
wherein a first terminal of the fifth switching transistor is electrically connected to the second connection point, and a second terminal of the fifth switching transistor is electrically connected to the voltage output terminal.

5. The buck circuit according to claim 2, wherein the switching control module is further configured to control the first power transistor and the second power transistor to remain on, and control the third power transistor and the fourth power transistor to remain off, and control the first switching module and the second switching module to remain on to implement a pass-through mode.

6. The buck circuit according to claim 2, further comprising: a third switching module;
wherein the second switching module is electrically connected to the voltage output terminal via the third switching module; and a common connection point between the third switching module and the second switching module is electrically connected to one terminal of a battery, and another terminal of the battery is grounded; and
the switching control module is electrically connected to the third switching module, and is configured to control the third switching module to turn on to charge the battery when a voltage of the battery is less than a first predetermined value or supply a voltage to the voltage input terminal via a battery when a voltage input at the voltage output terminal is less than a second predetermined value.

7. The buck circuit according to claim 1, wherein the first switching module comprises a first switching transistor and a second switching transistor;
wherein a first terminal of the first switching transistor is electrically connected to a first terminal of the second switching transistor, a second terminal of the first switching transistor is electrically connected to the first terminal of the first capacitor, and a second terminal of the second switching transistor is electrically connected to the second connection point.

8. The buck circuit according to claim 7, further comprising: a second switching module, wherein one terminal of the second switching module is electrically connected to the first terminal of the first switching transistor, and another terminal of the second switching module is electrically connected to the voltage output terminal; and
the switching control module is electrically connected to the second switching module, and is further configured to generate a switching drive signal with a duty cycle of 50% and control on or off of the first power transistor, the second power transistor, the third power transistor, and the fourth power transistor, and meanwhile control the first switching module and the second switching module to turn on to implement functionality of a charge pump.

9. The buck circuit according to claim 8, wherein the second switching module comprises a third switching transistor and a fourth switching transistor;
wherein a first terminal of the third switching transistor is electrically connected to a first terminal of the fourth switching transistor, a second terminal of the third switching transistor is electrically connected to the first terminal of the first switching transistor, and a second terminal of the fourth switching transistor is electrically connected to the voltage output terminal.

10. The buck circuit according to claim 8, wherein the second switching module comprises a fifth switching transistor;
wherein a first terminal of the fifth switching transistor is electrically connected to the first terminal of the first switching transistor, and a second terminal of the fifth switching transistor is electrically connected to the voltage output terminal.

11. The buck circuit according to claim 8, wherein the switching control module is further configured to control the first power transistor and the second power transistor to remain on, and control the third power transistor and the fourth power transistor to remain off, and control the first switching module and the second switching module to remain on to implement a pass-through mode.

12. The buck circuit according to claim 8, further comprising: a third switching module; wherein
the second switching module is electrically connected to the voltage output terminal via the third switching module; and a common connection point between the third switching module and the second switching module is electrically connected to one terminal of a battery, and another terminal of the battery is grounded; and
the switching control module is electrically connected to the third switching module, and is configured to control the third switching module to turn on to charge the battery when a voltage of the battery is less than a first predetermined value or supply a voltage to the voltage input terminal via a battery when a voltage input at the voltage output terminal is less than a second predetermined value.

13. The buck circuit according to claim 12, wherein the third switching module comprises a sixth switching transistor; wherein a first terminal of the sixth switching transistor is electrically connected to the second switching module, and a second terminal of the sixth switching transistor is electrically connected to the voltage output terminal.

14. The buck circuit according to claim 12, wherein the second switching module comprises a seventh switching transistor; wherein a first terminal of the seventh switching transistor is electrically connected to the first terminal of the first switching transistor, and a second terminal of the seventh switching transistor is electrically connected to a common connection point between the third switching module and the second switching module.

15. A control method for a buck circuit, applicable to a buck circuit, wherein the buck circuit comprises: a first power transistor, a second power transistor, a third power transistor, a fourth power transistor, a flying capacitor, an inductor, a first capacitor, a first switching module, and a switching control module; wherein a first terminal of the first power transistor is electrically connected to a voltage input terminal, a second terminal of the first power transistor and a first terminal of the second power transistor are electrically connected to a first connection point, a second terminal of the second power transistor and a first terminal of the third power transistor are electrically connected to a second connection point, a second terminal of the third power transistor and a first terminal of the fourth power transistor are electrically connected to a third connection point, and a second terminal of the fourth power transistor is grounded; one terminal of the flying capacitor is electrically connected to the first connection point, and another terminal of the flying capacitor is electrically connected to the third connection point; and one terminal of the inductor is electrically connected to the second connection point, and another terminal of the inductor is electrically connected to a voltage output terminal; a first terminal of the first capacitor is electrically connected to the second connection point via the first switching module, and a second terminal of the first capacitor is grounded; the switching control module is electrically connected to control terminals of the first power transistor, the second power transistor, the third power transistor, the fourth power transistor, and the first switching module; and
the method comprises:
controlling, by the switching control module, the first switching module to turn on when controlling the first power transistor and the third power transistor to turn on such that the first capacitor and the flying capacitor are connected in series; and
controlling, by the switching control module, the first switching module to turn on when controlling the second power transistor and the fourth power transistor to turn on such that the first capacitor and the flying capacitor are connected in parallel.

16. The control method according to claim 15, wherein the buck circuit further comprises: a second switching module, wherein one terminal of the second switching module is electrically connected to the second connection point, and another terminal of the second switching module is electrically connected to the voltage output terminal; and
the switching control module is electrically connected to the second switching module; wherein,
the method further comprise:
generating, by the switching control module, a switching drive signal with a duty cycle of 50% and controlling on or off of the first power transistor, the second power transistor, the third power transistor, and the fourth power transistor, and meanwhile controlling the first switching module and the second switching module to turn on to implement functionality of a charge pump.

17. The control method according to claim 15, wherein the second switching module comprises a third switching transistor and a fourth switching transistor;
wherein a first terminal of the third switching transistor is electrically connected to a first terminal of the fourth switching transistor, a second terminal of the third switching transistor is electrically connected to the second connection point, and a second terminal of the fourth switching transistor is electrically connected to the voltage output terminal.

18. The control method according to claim 15, wherein the first switching module comprises a first switching transistor and a second switching transistor;
wherein a first terminal of the first switching transistor is electrically connected to a first terminal of the second switching transistor, a second terminal of the first switching transistor is electrically connected to the first terminal of the first capacitor, and a second terminal of the second switching transistor is electrically connected to the second connection point.

19. The control method according to claim 18, wherein the buck circuit further comprises: a second switching module, wherein one terminal of the second switching module is electrically connected to the first terminal of the first switching transistor, and another terminal of the second switching module is electrically connected to the voltage output terminal; and
the switching control module is electrically connected to the second switching module; wherein,
the method further comprises:
generating, by the switching control module, a switching drive signal with a duty cycle of 50% and controlling on or off of the first power transistor, the second power transistor, the third power transistor, and the fourth power transistor, and meanwhile controlling the first switching module and the second switching module to turn on to implement functionality of a charge pump.

20. An electronic device, comprising: an adapter and a buck circuit; wherein
the adapter is electrically connected to the buck circuit, and is configured to convert an input alternating current voltage to a direct current voltage, and output the direct current voltage to the buck circuit;
the buck circuit comprises: a first power transistor, a second power transistor, a third power transistor, a fourth power transistor, a flying capacitor, an inductor, a first capacitor, a first switching module, and a switching control module; wherein
a first terminal of the first power transistor is electrically connected to a voltage input terminal, a second terminal of the first power transistor and a first terminal of the second power transistor are electrically connected to a first connection point, a second terminal of the second power transistor and a first terminal of the third power transistor are electrically connected to a second connection point, a second terminal of the third power transistor and a first terminal of the fourth power transistor are electrically connected to a third connection point, and a second terminal of the fourth power transistor is grounded; one terminal of the flying capacitor is electrically connected to the first connection point, and another terminal of the flying capacitor is electrically connected to the third connection point; and one terminal of the inductor is electrically connected to the second connection point, and another terminal of the inductor is electrically connected to a voltage output terminal;
a first terminal of the first capacitor is electrically connected to the second connection point via the first switching module, and a second terminal of the first capacitor is grounded;
the switching control module is electrically connected to control terminals of the first power transistor, the second power transistor, the third power transistor, the fourth power transistor, and the first switching module, and is configured to control the first switching module to turn on when controlling the first power transistor and the third power transistor to turn on such that the first capacitor and the flying capacitor are connected in series, and further configured to control the first switching module to turn on when controlling the second power transistor and the fourth power transistor to turn on such that the first capacitor and the flying capacitor are connected in parallel.
